(19) United States
(12) Patent Application Publication
(10) Pub. No.: US 2005/0193700 A1
(43) Pub. Date: Sep. 8, 2005

(54) Hydraulically-powered edge trimmer apparatus

(76) Inventor: Michael Bares, Abbeville, LA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 11/105,928

(22) Filed: Apr. 14, 2005

Related U.S. Application Data
(63) Continuation-in-part of application No. 11/023,237, filed on Dec. 27, 2004.
Application No. 11/023,237 is a continuation-in-part of application No. 10/713,925, filed on Nov. 14, 2003, now Pat. No. 6,892,518.

(51) Int. Cl. A01D 34/00

(52) U.S. Cl. 56/12.7

(57) ABSTRACT

A trimmer assembly for a lawn mower is detachably mountable on a deck of the lawn mower by a housing or shroud that can be secured to the front edge of the deck A mounting frame is pivotally attached to the housing. The mounting frame carries a trimmer head with a plurality of cutting elements secured thereto. The mounting frame and the trimmer head pivotally move between an operational and a non-operational position by a swivel arm secured to the mounting frame. The trimmer head is powered by a hydraulic motor, which operates independently from the operation of the lawn mower.

### CROSS-REFERENCE TO RELATED APPLICATIONS

This application is a continuation-in-part of my co-pending application Ser. No. 11/023,237 filed on Dec. 27, 2004, entitled “Hydraulically-Powered Edge Trimmer Assembly,” which is a continuation-in-part of my co-pending application Ser. No. 10/713,925 filed on Nov. 14, 2003, entitled “Edge Trimmer Assembly Mountable on a Lawn Mower,” the full disclosures of which are incorporated by reference herein, and priority of which is claimed.

### FIELD OF THE INVENTION

The present invention generally relates to trimmer devices, and more particularly to an edge trimmer device adapted for attachment to a power lawn mower.

### BACKGROUND OF THE INVENTION

Lawn mowers are extensively used by homeowners and commercial services alike. Conventional lawn mowers are generally provided of a walk-behind type and a riding type. When cutting grass it becomes often desirable to cut the edges of the lawn along the sidewalks, around the trees, shrubs and other structures. This task is usually performed using an edge trimmer that allows the user to get closer to the structures, around which the grass needs to be cut.

The conventional trimmers are usually of a string type and can be powered by a gasoline engine or by AC electric power. The edge trimmer is a device sold separately and used separately from a lawn mower. A collection of lawn mowers, edge trimmers, leaf blowers and other such yard devices, takes up valuable storage space in a garage or in equipment shed of a homeowner.

Various attempts have been made to combine the lawn mower with an edge trimmer to reduce the number of steps the user performs when trimming vegetation. However, most of these attempts result in expensive, cumbersome machines that take up considerable space in a tool shed or equipment storehouse of a homeowner.

The present invention contemplates elimination of the drawbacks associated with conventional devices for cutting grass and provision of a grass trimmer that is adapted for mounting on a lawn mower, for instance a riding lawn mower to facilitate and expedite the task of cutting grass with the assistance of a hydraulic motor.

### SUMMARY OF THE INVENTION

It is, therefore, an object of the present invention to provide an edge trimmer apparatus that can be detachably mounted on a lawn mower without substantial retrofitting of the lawn mower itself.

It is another object of the present invention to provide a trimmer attachment adapted for retrofitting existing power lawn mower of conventional design.

It is a further object of the present invention to provide an edge trimmer apparatus that allows the trimmer head to articulate in a vertical plane, while allowing the support arm to articulate in both horizontal and vertical planes.

These and other objects of the present invention are achieved through a provision of an edge trimmer apparatus, which is adapted for detachable mounting on a deck of an existing lawn mover. The trimmer assembly has a mounting plate, which detachably attaches to the lawn mower and a swivel arm that supports the edge trimmer head on its distant end. The edge trimmer head is connected to an elongated extendable rotation shaft carried by the swivel arm.

The trimmer head is pivotally movable in a vertical plane about a pivot pin, or gimble that is secured to a yoke, which is, in turn, secured to the shaft. A worm gear assembly connected to a power means allows to move the trimmer head to any of a plurality of selected inclined positions in relation to the shaft. The trimmer head carries a plurality of cutting members for cutting vegetation in the desired area.

The swivel arm is hindgedly connected to the mounting plate and moves between an operational position, with the trimmer head in close proximity to the ground and a non-operational position, with the trimmer head elevated above the deck of the lawn. The swivel arm moves in vertical and horizontal planes, allowing the edge trimmer head to reach sideways for cutting vegetation in a desired area, move downwardly when cutting vegetation in a ditch or a location below the lawn mower level.

The trimmer assembly can be powered by a battery or a hydraulic motor independently from the lawn mower power source. Alternatively, the trimmer head may be powered by the lawn mower power supply by connection of the trimmer head to a power take-off connection of the lawn mower.

### BRIEF DESCRIPTION OF THE DRAWINGS

Reference will now be made to the drawings, wherein like parts are designated by like numerals, and wherein

FIG. 1 is a plan view of the edge trimmer apparatus of the present invention mounted on an existing lawn mower deck in an operating position.

FIG. 2 is a front view of the edge trimmer apparatus of the present invention mounted on an existing lawn mower deck movable between an operating position and a non-operating, stowed position.

FIG. 3 is a detail schematic plan view of the shaft carrying the edge trimmer head.

FIG. 4 is a detail schematic side view of the shaft carrying the trimmer head.

FIG. 5 is a detail schematic side view of the trimmer head pivoted 90 degrees in relation to the ground.

FIG. 6 is a detail schematic side view of the trimmer head pivoted 45 degrees in relation to the ground level.

FIG. 7 is detail schematic side view illustrating extension of the shaft.

FIG. 8 is a detail schematic plan view illustrating movement of the trimmer head.

FIG. 9 is a detail schematic view illustrating pivotal movement of the trimmer head extending substantially perpendicularly to the mower deck in an open/close position.

FIG. 10 is a schematic view illustrating pivotal movement of the edge trimmer when working in an open ditch.

FIG. 11 is a schematic sectional view illustrating a bearing assembly of the trimmer head connected to the power source through a flexible shaft.

FIG. 12 is a detail view illustrating an electric power means used instead of a hydraulic motor in the apparatus of the present invention.

FIG. 13 is a schematic side view illustrating delivery of an hydraulic power force to the edge trimmer.

FIG. 14 is a schematic detail view illustrating a worm gear assembly powered by either electric or hydraulic power source and using a worm gear assembly.

FIG. 15 is a schematic detail view illustrating a spur gear assembly powered by a hydraulic power means and using a spur gear assembly.

FIG. 16 is a schematic view of the edge trimmer apparatus mounted on a deck of a mower and powered by an electric power source.

FIG. 17 is a schematic view of a hydraulic circuit powering the apparatus of the present invention.

FIG. 18a is a detail side view of a mount plate for securing the edge trimmer apparatus to a deck of the lawn mower.

FIG. 18b is a detail plan view of another embodiment of the mount plate for securing the edge trimmer apparatus to a deck of the lawn mower.

FIG. 18c is a detail side view of the mount plate of FIG. 18b for securing the edge trimmer apparatus to a deck of the lawn mower.

FIG. 18d is a detail plan view of third embodiment of a mount plate for securing the edge trimmer apparatus to a deck of the lawn mower.

FIG. 18e is a detail side view of the mount plate of FIG. 18d for securing the edge trimmer apparatus to a deck of the lawn mower.

### DETAILED DESCRIPTION OF THE PREFERRED EMBODIMENT

Turning now to the drawings in more detail, the trimmer assembly of the present invention is generally designated by numeral 10. The trimmer assembly 10 is adapted for mounting to a deck 12 of a conventional lawn mower 11. A conventional lawn mover 11 has a power means 13 that provides power to control pedals 14a, 14b, 14c and 14d for rotating grass cutting blades (not shown) rotating below the deck 12. A plurality of driving shafts (not shown) carry an endless belt of the lawn mover that transmits force between the power driven shafts and the cutting blades.

A mounting plate 16 is secured to the deck 12. The mounting plate 16 supports the edge trimmer apparatus of the present invention. The mounting plate 16 may be fixedly or detachably secured to the deck 12 by bolts or other securing means. A flexible shaft 18 connects the power means 13 of the lawn mower 11, through a power take-off connection 15, with an edge trimmer head assembly 20 of the apparatus of the present invention. The trimmer head assembly 20 comprises a bearing housing 36, a feeder 22 and a cutter string 24, which trims the vegetation when being rotated.

A swivel arm 26 moves the edge trimmer apparatus between an operating position, with the edge trimmer head assembly 20 being lowered down, and a stowed position, with the edge trimmer head 20 being lifted away from the ground, as shown in a vertical position in FIG. 2. A hinge unit 28 allows movement of the swivel arm 26 between the operating and non-operating positions, as well as inclining of the trimmer head assembly 20 to a desired angle when required for trimming around fences, in ditches and the like, as will be explained in more detail hereinafter.

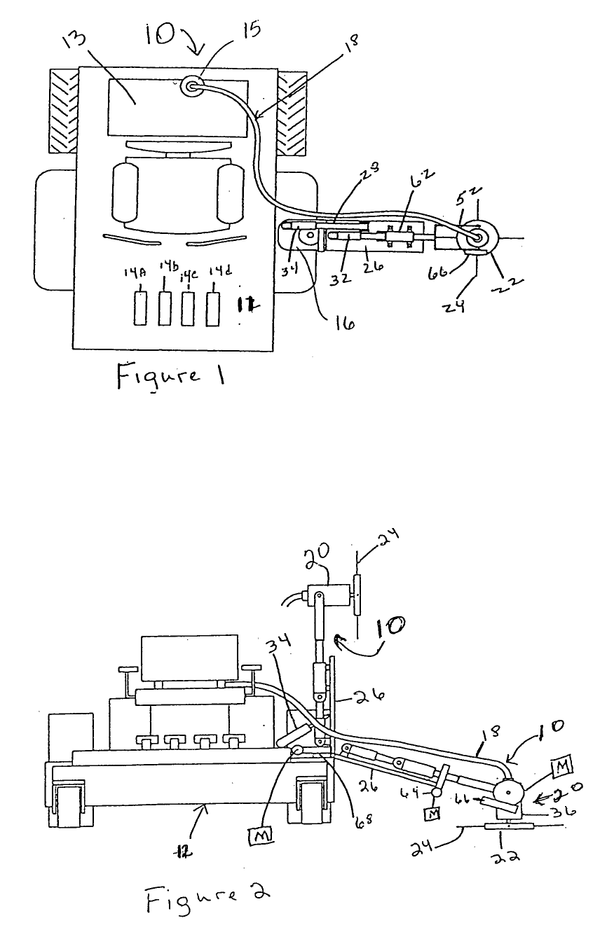

The trimmer head assembly 20 is secured to a free end of the swivel arm 26. The trimmer head assembly 20 is operationally connected to a hydraulic power means 30, through a pair of hydraulic cylinders 32, 34, as shown I FIG. 1. The bearing housing 36 houses one or more inner bearing assemblies 38, 40 (FIG. 10) journalled to a journal 37, which facilitate rotation of the feeder head 22 and the string 24, The inner bearing assemblies 38 and 40 are operationally connected to the power means 13 through the shaft 18.

Referring now to FIGS. 3-10, the movement of the trimmer head in relation to the ground level is shown in more detail. As can be seen in the drawings, the apparatus of the present invention comprises an extendable rotation shaft 50, which is connected to the power source 30 through the hydraulic cylinder 32. The shaft 50 is received within a yoke 52 having a generally U-shaped configuration. Free ends 54 and 56 of the yoke 52 are secured to the bearing housing with the help of a gimble 58, which facilitates pivotal movement of the bearing housing 36 in relation to the yoke and selected adjustment in the relative degree of positioning of the feeder 22 in relation to the ground.

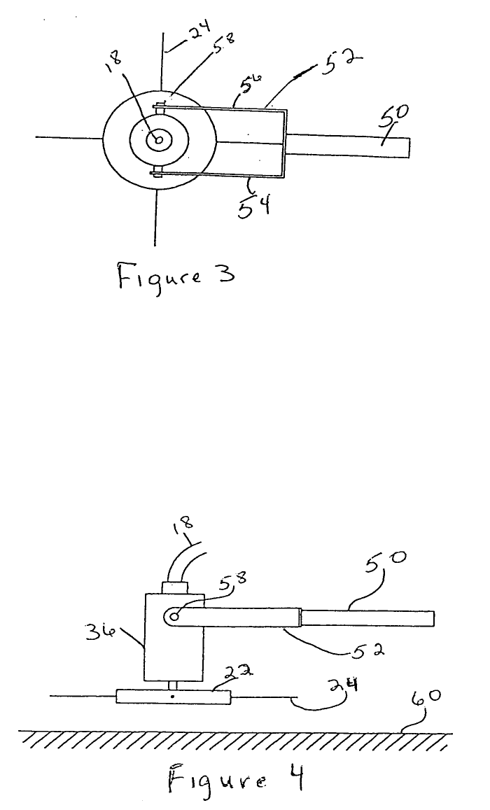

The pivotal connection of the trimmer head assembly 20 allows the user to selectively move the feeder head into a plurality of positions relative to the ground level and to the vegetation being cut. As shown in FIG. 4, the feeder head 22 can be oriented almost parallel to the ground level 60, with the bearing housing extending downwardly from the yoke 52. This position is referred to as “zero level” position. In this position, grass and small bushes can be trimmed using the apparatus 10. The relative position of the trimmer head, and hence of the feeder head 22, can be gradually adjusted in both the vertical and horizontal planes due to the provision of the hinge 28 and the joke 52.

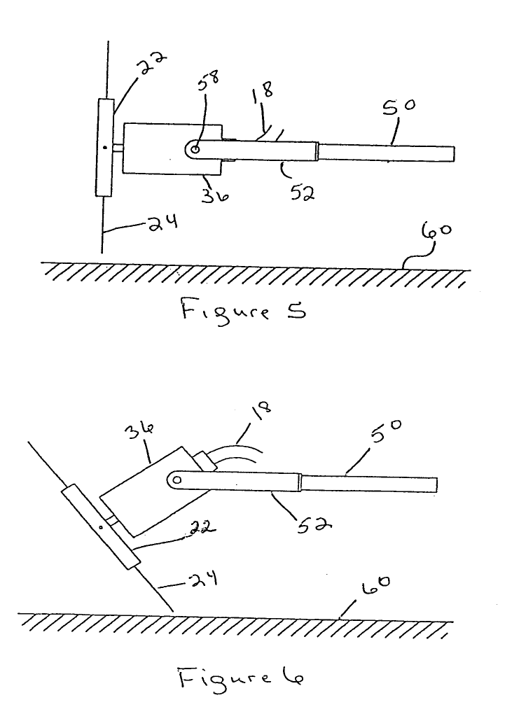

FIG. 5 illustrates pivotal movement of the feeder 22, with the feeder oriented at almost right angle in relation to the ground level 60. This position of the feeder head may be used when the apparatus 10 is in a stowed position. In this position, the bearing housing 36 supports the feeder in a substantially vertical orientation.

FIG. 6 illustrates an angular orientation of the feeder 22 in relation to the ground level 60. For instance, the angle of inclination may be 45 degrees, or other such selected angle as required for the job. In this position, the string 24 can be used to cut vegetation along edges and close to a sidewalk.

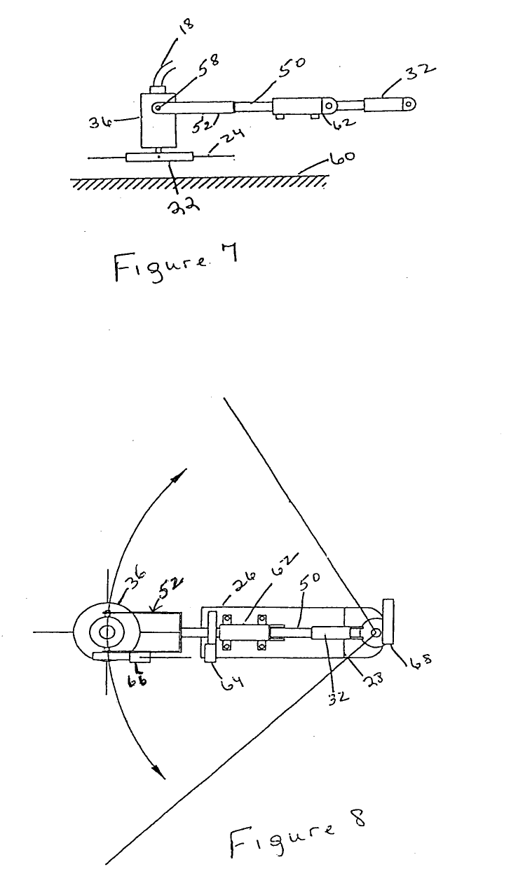

FIG. 7 illustrates extension of the shaft 50 to allow the user to reach farther from the lawn mover deck 12. As can be seen in FIG. 7, a linear bearing assembly 62 is positioned in axial alignment with the shaft 52. Depending on the design, the shaft 50 may be extended between 14 and 20 inches. Of course, the extension distance can be reduced or enlarged as desired, by providing desired variations in the shaft extension capabilities. It is envisioned that the trimmer head will be able to move about 45 degrees in relation to a longitudinal axis of the pivotal arm 26 and that the swivel arm 26 will be able to move about 60 degrees in a horizontal plane, as schematically shown in FIG. 8.

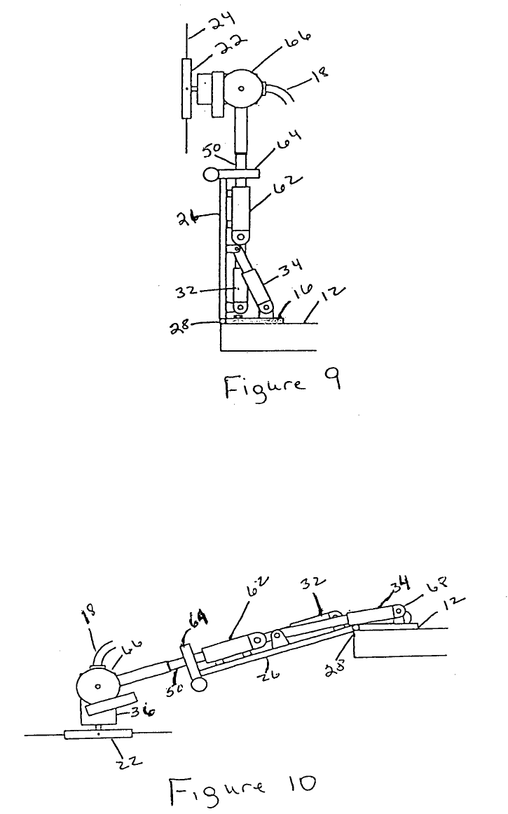

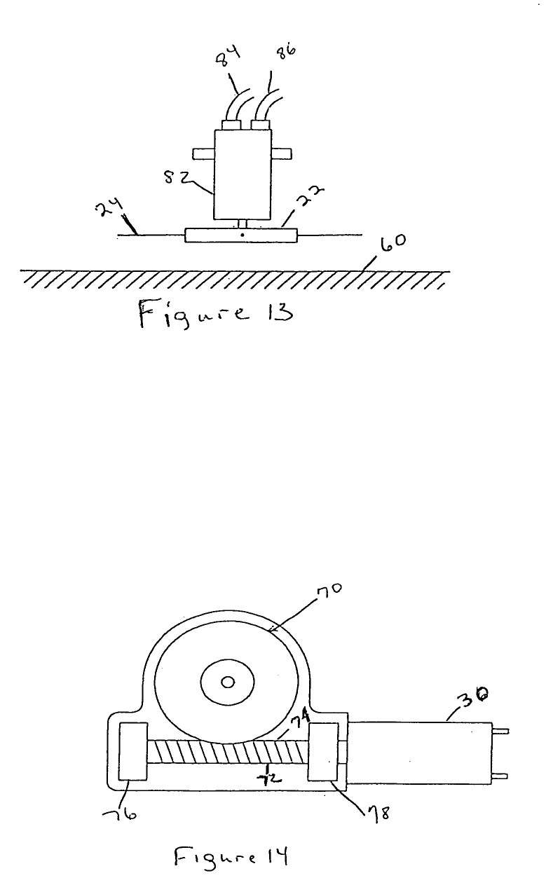

To facilitate relative movement of the shaft 50 and pivotal movement of the trimmer head, one or more worm gear assemblies may be employed in the apparatus of the present invention. One of such worm gear assemblies 64 (shown in more detail in FIG. 14) may be positioned in line with the linear bearing 62 in location between the linear bearing 62 and the yoke 52. Another worm gear assembly 66 may be positioned between the yoke 52 and the bearing housing 36. The worm gear assembly 64 causes rotation and extension of the shaft 50; the worm gear assembly 66 causes pivotal movement of the feeder head 22 in the yoke 52, moving it up and down in a vertical plane. Still another worm gear assembly 68 is positioned on the deck 12 of the lawn mower 11 and causes lifting and lowering of the swivel arm 26 from an operational position to a stowed position, as shown in FIG. 9.

Each of the worm gear assemblies 64, 66 or 68 comprises a gear wheel 70 and a an elongated shaft 72. The worm gear shaft 72 has an endless thread 74, which marches threads (not shown) on the worm gear wheel 70. The worm gear shaft 72 is operationally connected to the power source 30, which can be a hydraulic motor (or electric direct current motor, if desired). The worm gear shaft 72 is journalled between rotating bearing units 76 and 78. As the power is supplied to the worm gear shaft 72, causing its axial rotation, the rotational force is transmitted to the worm gear wheel 70 through the marching threads on the gear wheel 70 and the threads 74 on the elongated worm gear shaft 72. Each worm gear assembly is connected to a motor M.

FIG. 9 illustrates the apparatus 10 of the present invention in stowed position. The hinge assembly 28 allows the user to move the swivel arm 26 and the connected shaft 50 about a vertical plane, raising the feeder head 22 above the mower deck 12. Such position removes the rotating portions of the apparatus 10 from an immediate reach of the user and protects the user from accidental injury by the trimmer assembly.

FIG. 10 illustrates position of the shaft 50 when the feeder head 22 is lowered substantially below the level of the lawn mower deck 12. Such position may be required when the user wishes to cut vegetation in an open ditch. As shown in the drawing, the swivel arm 26 pivots about the hinge 28, inclining the shaft 50 and the bearing housing 36. If desired, the shaft 50 may be extended to reach the sides of the ditch to perform the necessary trimming job.

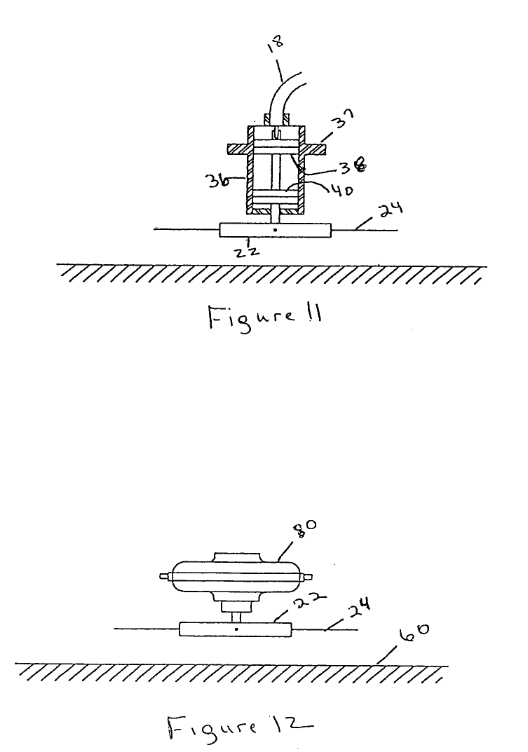

FIG. 12 schematically illustrates connection of the feeder 22 to an alternative power source, in this case a direct current motor 80, which can be secured directly on the shaft 50. FIG. 13 illustrates connection of the feeder head 22 directly to a hydraulic motor 82, which can be connected to the lawn mower power source 30 with the help of hydraulic lines 84, 86. Such design is an improvement over convention connection of the bearings to a drive pulley and rotating belt. FIG. 15 illustrates an alternative gear assembly, which can be used between hydraulic pistons 32, 34. In this embodiment, a spur gear wheel 88 is mounted under a protective shroud 90. A tooth rack 92 extends between the cylinders 32, 34. The rack 92 is provided with a plurality of teeth 94, which are configured to matchingly engage with teeth 96 of the spur gear 88. The spur gear assembly allows 90-degree movement between adjoining members.

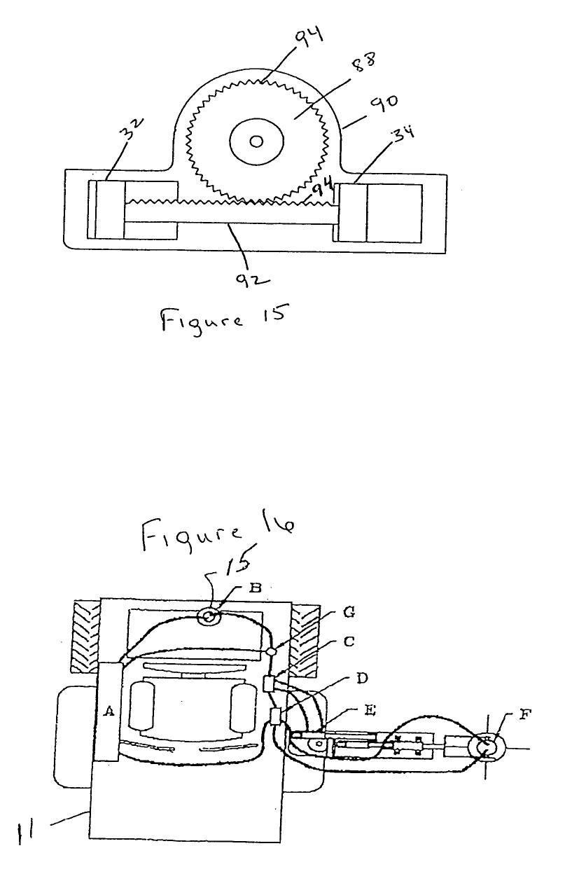

FIGS. 16 and 17 illustrate power transmittal between alternative sources of power, being it a power take off connection 15 (designated by letter “B” in FIG. 16) or independent power sources, such a hydraulic motor, or an electric motor powered by a DC battery, which can be mounted on the deck 12 of the lawn mower 11. Conventional switches (not shown) are provided for delivering power to the worm gear assemblies and the trimmer head to facilitate movement of the swivel arm 26, the trimmer head 20 into a plurality of selected positions. It is preferred that each rotating member of the apparatus of the present invention be enclosed in its own independent shield to ensure safety of operation.

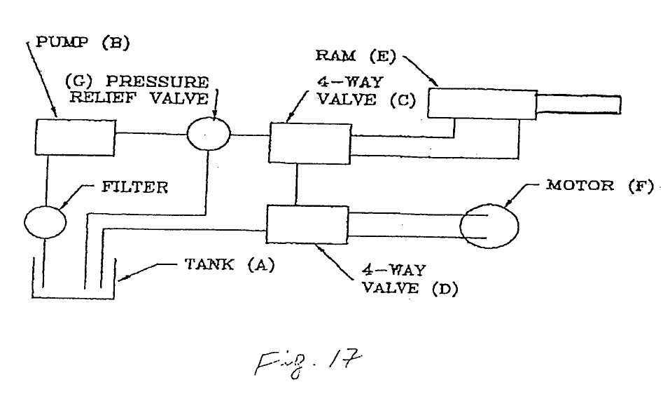

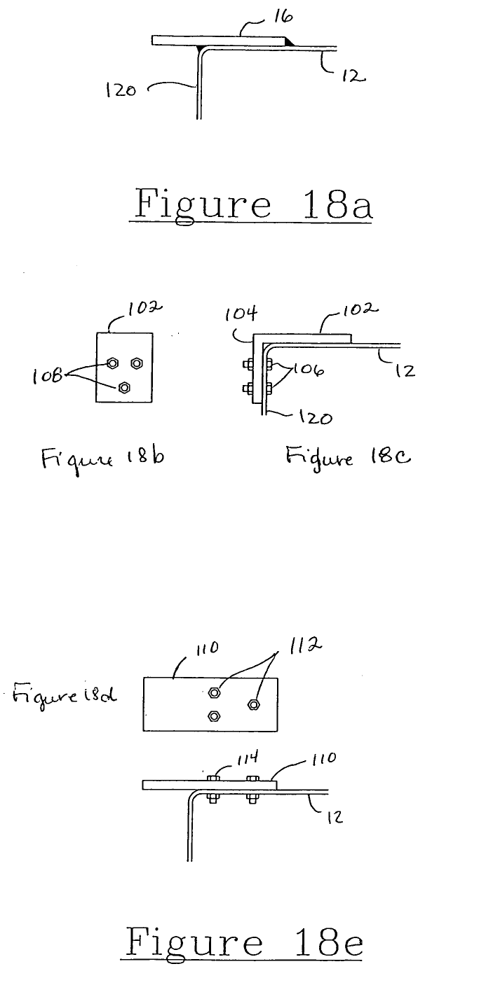

FIGS. 18a-18e illustrate in detail a mount plate suitable for attaching the edge trimmer apparatus of the present invention to the deck of a lawn mower. As can be seen in FIG. 18a, the mounting plate 16 can be welded to the deck 12 and extend slightly outwardly from a vertical wall 120 of the deck 12. Alternatively, as shown in FIGS. 18b and 18c, the mounting plate 102 may be formed as an L-shaped body having a first portion resting on the deck 12 and a vertical portion 104 extending downwardly along the wall 120. A plurality of securing bolts 106 extend through openings 108 formed in the portion 104. In still another embodiment, shown in FIGS. 18d and 18e, the mounting plate may have 110 may be formed as a planar body provided with a plurality of openings 112 adapted for receiving a plurality of securing bolts 114 therethrough. The bolts pass through the openings 112 and engage the top of the deck 12, thereby detachably securing the apparatus of the present invention to the lawn mower deck 12.

The trimmer assembly of the present invention is easily positioned and easily detached from a conventional lawn mower. The conventional lawn mowers may be inexpensively and relatively easy retrofitted with the trimmer assembly of the present invention. Since the trimmer assembly is mountable on the existing structure it does not require as much space for storage as conventional edge trimmers.

The present invention provides for a hydraulic or electric motor as a drive option for operating the edge trimmer assembly independently of the lawn mower. The ease of rotating the cutter head facilitates the grounds maintenance operation and allows the user to cut thicker vegetation, if necessary without necessarily engaging the lawn mower. It is envisioned that other power drive options, such as for instance a re-chargeable battery, will become apparent to those skilled in the art. It is envisioned that the pivotal movement of the trimmer attachment may be performed by moving the hinge along a vertical rotational axis, while moving the swivel arm along a horizontal rotating axis, if desired.

Many other changes and modifications may be made in the design of the present invention without departing from the spirit thereof. I, therefore, pray that my rights to the present invention be limited only by the scope of the appended claims.

1. An edge trimmer apparatus mountable on a lawn mower having a mower deck, the trimmer assembly comprising:
a a trimmer head;
a swivel arm supporting the trimmer head a distance from the mower deck;
a means for pivotally connecting the swivel arm to the mower deck to facilitate movement of the trimmer head between a plurality of selected operational positions and a non-operational position in relation to the mower deck; and
a means for pivotally moving the trimmer head independently from the swivel arm.

2. The apparatus of claim 1, wherein said means for pivotally connecting the swivel arm comprises a mounting plate configured for detachable mounting on the mower deck and a hinge assembly supported by the mounting plate and secured to a proximate end of the swivel arm.

3. The apparatus of claim 1, wherein said swivel arm is adapted for pivotal movement between an operation position extending the trimmer head in close proximity to the ground and a non-operational position elevating the trimmer head above the mower deck.

4. The apparatus of claim 2, wherein said means for pivotally moving the swivel arm further comprises a gear assembly connected to a power means.

5. The apparatus of claim 1, wherein said means for pivotally moving the trimmer head comprises a shaft supporting the trimmer head, a yoke carried by a distant end of the shaft and pivot pin secured in the yoke, the pivot pin supporting the trimmer head.

6. The apparatus of claim 5, further comprising a means for extending longitudinal dimension of said shaft upon demand, said means comprising a gear assembly mounted on said shaft and connected to a power means.

7. The apparatus of claim 5, wherein said means for pivotally moving said trimmer head further comprises a worm gear assembly secured on said shaft.

8. The apparatus of claim 1, wherein said trimmer head is configured for pivotal movement along a vertical axis and said swivel arm is configured for movement along vertical and horizontal axes.

9. The apparatus of claim 1, further comprising a power source for transmitting rotation power to the trimmer head and pivotal force to the trimmer head and the swivel arm.

10. The apparatus of claim 9, wherein said power source is a direct current electric power source.

11. The apparatus of claim 9, wherein said power source is a hydraulic motor.

12. An edge trimmer apparatus mountable on a lawn mower having a mower deck, the trimmer assembly comprising:
a trimmer head;
a swivel arm supporting the trimmer head a distance from the mower deck, said swivel arm moving in a horizontal place and a vertical plane;
a means for pivotally connecting the swivel arm to the mower deck to facilitate movement of the trimmer head between a plurality of selected operational positions and a non-operational position in relation to the mower deck; and
a means for pivotally moving the trimmer head independently from the swivel arm.

13. The apparatus of claim 12, wherein said means for pivotally connecting the swivel arm comprises a mounting plate configured for detachable mounting on the mower deck, a hinge assembly supported by the mounting plate and secured to a proximate end of the swivel arm, and a worm gear assembly mounted on the mounting plate, said worm gear assembly being connected to a power means.

14. The apparatus of claim 12, wherein said means for pivotally moving the trimmer head comprises an elongated shaft supporting the trimmer head, a yoke carried by a distant end of the shaft, a pivot pin secured in the yoke, the pivot pin supporting the trimmer head, and a worm gear connected to said shaft.

15. The apparatus of claim 14, wherein said shaft is operationally connected to a gear assembly to facilitate longitudinal extension of said shaft upon demand.

16. The apparatus of claim 12, further comprising a power source for transmitting rotation power to the trimmer head and pivotal force to the trimmer head and the swivel arm.

17. The apparatus of claim 16, wherein said power source is a direct current electric power source.

18. The apparatus of claim 16, wherein said power source is a hydraulic motor.

19. The apparatus of claim 12, wherein said swivel arm is adapted for pivotal movement between an operation position extending the trimmer head in close proximity to the ground and a non-operational position elevating the trimmer head above the mower deck.

20. An edge trimmer apparatus mountable on a lawn mower having a mower deck, the trimmer assembly comprising:
a trimmer head;
a swivel arm supporting the trimmer head a distance from the mower deck, said swivel arm moving in a horizontal plane and a vertical plane, said swivel arm moving the trimmer head between any of a selected plurality of operational positions in close proximity to the ground and a non-operational position above the mower deck;
a means for pivotally connecting the swivel arm to the mower deck to facilitate movement of the trimmer head between a plurality of selected operational positions and a non-operational position in relation to the mower deck; and
a means for pivotally moving the trimmer head independently from the swivel arm.
